(19) United States
(12) Patent Application Publication
(10) Pub. No.: US 2007/0209045 A1
(43) Pub. Date: Sep. 6, 2007

(54) Carrier apparatus and carrier method of thin disc tray

(75) Inventor: Yutaka Watanabe, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/657,600

(22) Filed: Jan. 25, 2007

(30) Foreign Application Priority Data
Jan. 26, 2006 (JP) 2006-017319

(51) Int. Cl. G11B 33/02

(52) U.S. Cl. 720/600

(57) ABSTRACT

In a carrier apparatus and a carrier method of a thin disc and a thin disc tray which are accommodated in a disc cartridge, in order to contain the drawn disc tray without bending it, a rigidity of the thin disc tray is improved in a pressed direction when containing the thin disc tray by applying a certain degree of deflection to a plane of the thin disc tray at a time of containing the thin disc and the thin disc tray within the cartridge, whereby the thin disc tray is securely contained.

### FIELD OF THE INVENTION

The present invention relates to a carrier apparatus and a carrier method of a disc tray in a cartridge accommodating a plurality of thin information recording mediums, and more particularly, to a carrier apparatus and a carrier method provided with a mechanism preventing a bending from being generated at a time of containing a disc tray.

### DESCRIPTION OF RELATED ART

In recent years, an information society has been developed, and there is a remarkable improvement in a recording density of an external memory device for storing enormous information. In order to meet the demand of a high density in a field of an optical disc, there have been vigorously conducted a study of a method of making a light spot size small on the basis of making a wavelength of a laser short and making a numerical aperture of an objective lens high, a method of enabling a multilayer recording by increasing a transmission factor of the recording layer or the like. However, as it stands, a method of intending to make a capacity high by making a diameter of the optical spot small or making the recording layer multilayer is under a condition which comes close to a physical limit.

In recent days, in order to increase a storage capacity of the optical disc, there has been vigorously conducted a study of a method of making a volume memory density high on the basis of a multilayer recording or a hologram recording. However, in the multilayer recording, since the light is absorbed to some degree in each of the layers, a structure having several layers is considered to be practical. In the hologram recording, it is hard to anticipate to improve the recording density by making a spot narrow. Accordingly, in these techniques, it is extremely difficult to achieve the optical disc having a high capacity of a terabyte (TB) class.

On the other hand, there has been conducted a study of increasing the volume memory density by reducing a thickness of the information recording medium. In general, there has been widely executed research and development of a recording and reproducing technique using a thin disc constituted by a thin substrate having a thickness of about 0.1 mm. Further, there has been developed a technique of accommodating a plurality of thin discs in a cartridge manner, a technique of drawing the thin discs from the cartridge for recording and reproducing, or the like. In JP-A-2000-57678 and a description of Japanese Patent Application No. 2005-194066, there is disclosed a disc cartridge accommodating a lot of sets of the thin discs and thin disc trays (having a thickness of about some hundreds μm) holding them.

In the disc cartridge accommodating the thin discs and the thin disc trays as shown in the above description of Japanese Patent Application No. 2005-194066, when recording and reproducing information on the individual thin disc, the thin disc tray holding the thin disc to be recorded and reproduced is drawn from the disc cartridge, and the thin disc on the tray is accessed, as shown in FIG. 6A. After the end of the recording and reproducing, the drawn thin disc and thin disc tray are contained in the cartridge. In this case, since the thin disc tray is constituted by a member (made of PET or the like) having a thickness of about some hundreds μm and having a flexibility, there is generated a matter that the thin disc tray is bent by the pushing force for returning the thin disc tray into the cartridge and the discs can not be normally contained, as shown in FIG. 6B. Incidentally, in FIGS. 6A and 6B, an illustration of the thin disc is omitted for simplification, however, if the thin disc tray is bent, there is of course supposed that the thin disc held thereon is bent or falls away.

Particularly, in the disc cartridge aiming to achieve a high memory density, there is aimed to increase an accommodating number of the thin discs and make the thin disc tray further thinner, so that the problem mentioned above is considered to be more easily generated.

### BRIEF SUMMARY OF THE INVENTION

The present invention is made by taking the actual condition mentioned above into consideration, and an object of the present invention is to provide a carrier apparatus and a carrier method which can contain, in a disc cartridge accommodating thin discs and thin disc trays, the disc tray drawn from the disc cartridge without bending.

As a result of devoting himself to conduct a study while taking the object mentioned above into consideration, the inventor of the present invention achieves a fact that, when the thin disc and the thin disc tray are contained within the cartridge, a certain degree of “deflection” is applied to a plane of the thin disc tray so as to improve a rigidity of the thin disc tray in a direction in which the thin disc tray is pressed at a time of being contained, thereby securely containing the thin disc tray.

Particularly, as shown in FIGS. 1A and 1B, it is possible to improve the rigidity of the thin disc tray by pressing both corners of a drawn end of the thin disc tray in a downward direction and pressing a portion in the vicinity of a center of the end in an upward direction so as to generate a deflection near this end. Further, as shown in FIGS. 2A and 2B, the same effect as mentioned above can be obtained by pressing the portion in the vicinity of the center of the end in the downward direction as well as pressing both the corners of the drawn end of the thin disc tray in the upward direction. Alternatively, as shown in FIGS. 3A and 3B, the deflection may be generated in the portion from one corner of the end to the portion in the vicinity of the center by pressing the one corner and the portion in the vicinity of the center of the drawn end of the thin disc tray respectively in the upward and downward directions.

In this case, a description will be given later of a jig for drawing and containing the thin disc tray, and a means for generating the deflection of the thin disc tray as mentioned above. Further, in FIGS. 2A, 2B, 3A and 3B, an illustration of the thin disc held on the thin disc tray is omitted for simplification.

As a technical idea based on the conception mentioned above, in accordance with the present invention, there is provided a carrier apparatus for carrying a thin disc tray in a cartridge accommodating thin discs and thin disc trays holding the thin discs in a state of laminating a plurality of thin discs and thin disc trays in a non-fixed manner, comprising:

a containing means pressing a drawn end of the thin disc tray in a direction of containing into the cartridge; and

a deflecting means pressing a part of the drawn end of the thin disc tray in such a manner that a deflection is generated on the thin disc tray surface.

In the carrier apparatus of the thin disc tray in accordance with the present invention, the deflecting means may be constituted by a movable arm means brought into contact with one corner or both corners of the drawn end of the thin disc tray so as to press it.

In the carrier apparatus of the thin disc tray in accordance with the present invention, the deflecting means may change a degree of deflecting the thin disc tray surface in correspondence to the contained state of the thin disc tray.

In the carrier apparatus of the thin disc tray in accordance with the present invention, the deflecting means may be constituted by a taper member arranged so as to guide the thin disc tray such that one end or both ends of the thin disc tray which are parallel to a drawn direction thereof are deflected, at a time when the thin disc tray is drawn.

In accordance with the present invention, there is further provided a carrier method of carrying a thin disc tray in a cartridge accommodating thin discs and thin disc trays holding the thin discs in a state of laminating a plurality of thin discs and thin disc trays in a non-fixed manner, comprising the steps of:

pressing a drawn end of the thin disc tray in a direction of containing it into the cartridge; and

pressing a part of the drawn end of the thin disc tray in such a manner that a deflection is generated on the thin disc tray surface.

In the carrier method of the thin disc tray in accordance with the present invention, the deflection may be generated on the thin disc tray surface by using a movable arm means brought into contact with one corner or both corners of the drawn end of the thin disc tray so as to press it.

In the carrier method of the thin disc tray in accordance with the present invention, a degree of deflecting the thin disc tray surface may be changed in correspondence to the contained state of the thin disc tray.

In the carrier method of the thin disc tray in accordance with the present invention, the deflection may be generated on the thin disc tray surface by using a taper member arranged so as to guide the thin disc tray such that one end or both ends of the thin disc tray which are parallel to a drawn direction thereof are deflected, at a time when the thin disc tray is drawn.

As described above, in accordance with the present invention, it is possible to provide the carrier apparatus and the carrier method which can contain the drawn disc tray in the disc cartridge accommodating the thin discs and the thin disc trays without bending them.

### BRIEF DESCRIPTION OF THE SEVERAL VIEWS OF THE DRAWING

FIGS. 1A and 1B are views exemplifying a method of deflecting a thin disc tray in accordance with the present invention;

FIGS. 2A and 2B are views exemplifying a method of deflecting a thin disc tray in accordance with the present invention;

FIGS. 3A and 3B are views exemplifying a method of deflecting a thin disc tray in accordance with the present invention;

FIGS. 4A to 4C are views schematically showing a jig for drawing a thin disc tray from a cartridge and containing the thin disc tray in the cartridge, and a containing mechanism of the thin disc tray thereby, as an embodiment of a carrier apparatus and a carrier method of a thin disc tray in accordance with the present invention;

FIGS. 5A and 5B are views schematically showing a jig for drawing a thin disc tray from a cartridge and containing the thin disc tray in the cartridge, and a containing mechanism of the thin disc tray thereby, as the other embodiment of a carrier apparatus and a carrier method of a thin disc tray in accordance with the present invention; and

FIGS. 6A and 6B are views showing an aspect of drawing and containing a thin disc tray in a disc cartridge accommodating a thin disc and a thin disc tray in accordance with a prior art.

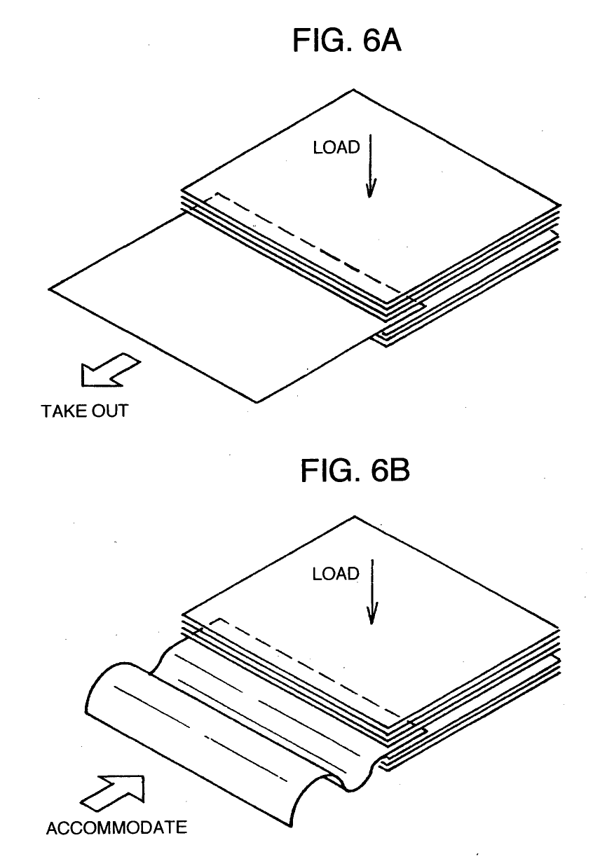

### DETAILED DESCRIPTION OF THE INVENTION

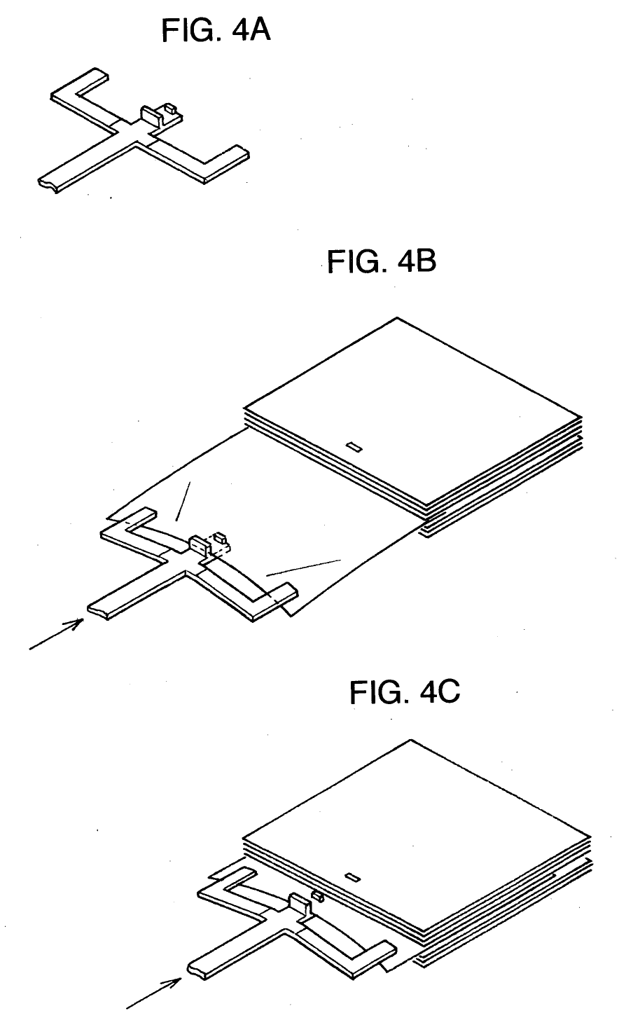

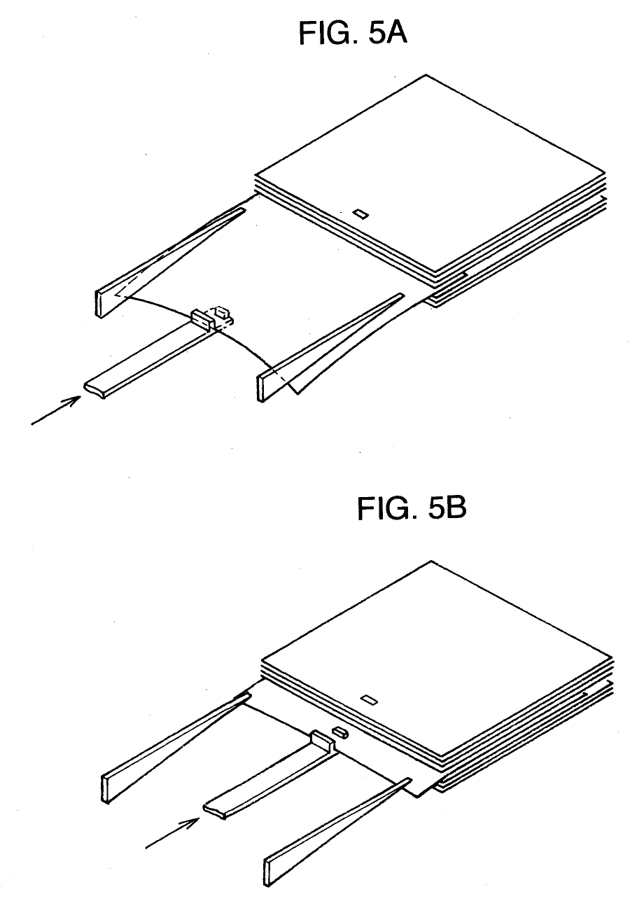

A description will be in detail given below of a best mode for carrying out a carrier apparatus and a carrier method of a thin disc tray in accordance with the present invention with reference to the accompanying drawings. FIGS. 4A to 5B are views exemplifying embodiments in accordance with the present invention. In these drawings, an illustration of a thin disc held on a thin disc tray is omitted for simplification. Further, it is desirable that the thin disc is protected by a cover or the like.

FIGS. 4A to 4C are views schematically showing a jig for drawing a thin disc tray from a cartridge and containing the thin disc tray in the cartridge, and a containing mechanism of the thin disc tray thereby, as an embodiment of the carrier apparatus and the carrier method of the thin disc tray in accordance with the present invention. As shown in FIG. 4A, the jig is constituted by an engagement portion with the thin disc tray extending to a center, and a movable type arm portion for deflecting both corners of the thin disc tray, which is connected to both ends of the engagement portion. A projection fitted to a drawing hole formed in an end of the thin disc tray is formed in a leading end of the engagement portion of the jig with the thin disc, and a wall for pressing the thin disc tray end is formed in an inner side thereof.

As shown in FIG. 4B, at a time of containing the thin disc tray within the cartridge, the movable type arm portion of the jig is bent at a fixed angle downwards so as to deflect downwards both corners of the thin disc tray brought into contact with the leading end while pressing the thin disc tray end by means of the above-mentioned wall, whereby the thin disc tray can be contained while preventing the thin disc tray from being bent. Further, as shown in FIG. 4C, it is preferable to cancel the bending of the movable type arm portion of the jig little by little in accordance that the thin disc tray is contained to some degree.

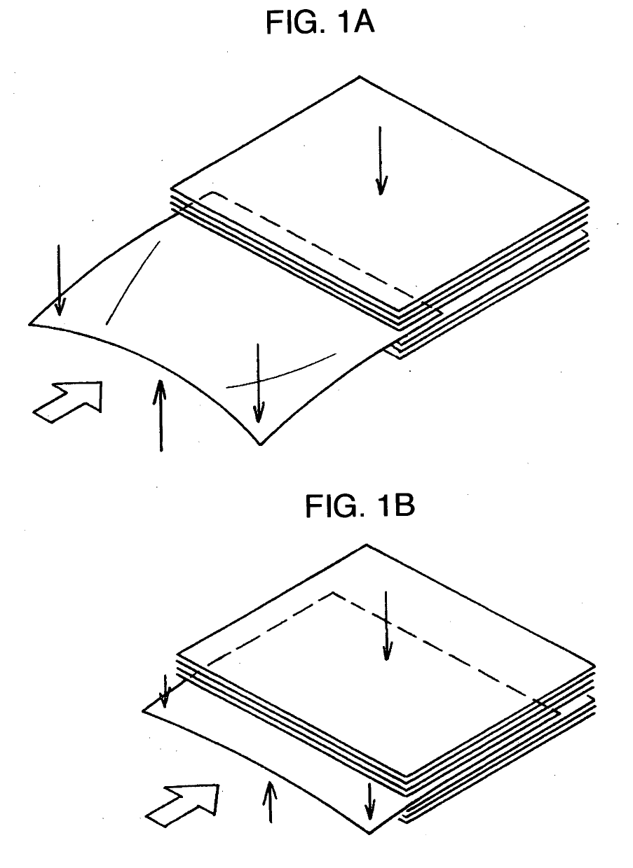

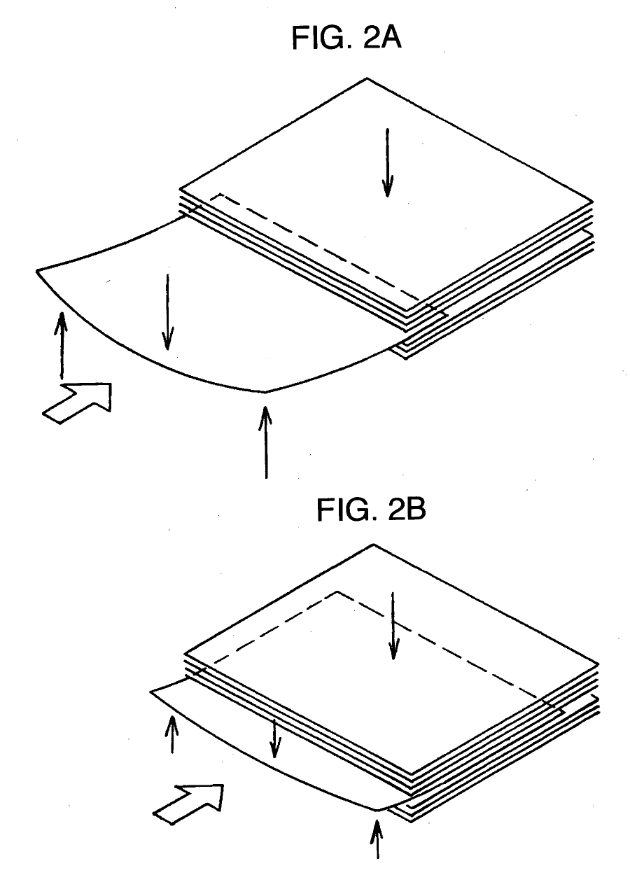

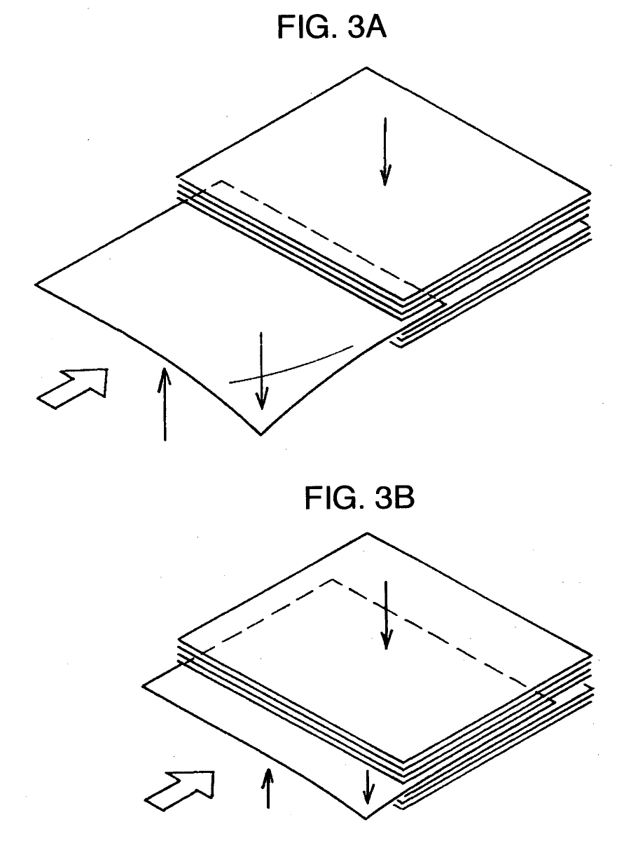

As described above, it is possible to contain the thin disc tray in accordance with an aspect shown in FIGS. 1A and 1B, by the containing mechanism using the jig shown in FIGS. 4A to 4C. Further, in the case that the movable type arm portion of the jig is bent upwards in place of being bent downwards, it is possible to contain the thin disc tray in accordance with an aspect shown in FIGS. 2A and 2B. Further, in the case that only one of the movable type arm portions of the jig is bent, it is possible to contain the thin disc tray in accordance with an aspect shown in FIGS. 3A and 3B (a jig provided only with one movable type arm portion may be used).

FIGS. 5A and 5B are views schematically showing a jig for drawing a thin disc tray from a cartridge and containing the thin disc tray in the cartridge, and an containing mechanism of the thin disc tray thereby, as the other embodiment of the carrier apparatus and the carrier method of the thin disc tray in accordance with the present invention. As shown in FIG. 5A, the jig is constituted by an engagement portion with the thin disc tray extending to a center, and a pair of taper members disposed on both ends thereof for deflecting both corners of the thin disc tray. The engagement portion of the jig with the thin disc is structured in the same manner as shown in FIGS. 4A to 4C.

As shown in FIGS. 5A and 5B, in a state of drawing the thin disc tray from the cartridge, both corners of the thin disc tray are in a state of deflecting them downwards, by the taper members of the jig. At a time of containing the thin disc tray within the cartridge from the above state, the structure is made such that the deflecting of both corners of the thin disc tray is canceled little by little by pressing the thin disc tray end by means of the wall of the engagement portion of the jig with the thin disc tray in accordance that the thin disc tray is contained, whereby it is possible to contain the thin disc tray while preventing the thin disc tray from being bent.

As described above, it is possible to contain the thin disc tray in accordance with the aspect shown in FIGS. 1A and 1B, by the containing mechanism using the jig shown in FIGS. 5A and 5B. Further, in the case that the taper members of the jig are arranged in such a manner that both corners of the thin disc tray are bent upwards in place of being bent downwards, it is possible to contain the thin disc tray in accordance with the aspect shown in FIGS. 2A and 2B. Further, in the case that the taper member is arranged only on any one of the right and left sides of the jig, it is possible to contain the thin disc tray in accordance with the aspect shown in FIGS. 3A and 3B.

The description is given above of the carrier apparatus and the carrier method of the thin disc tray in accordance with the present invention by exemplifying the particular embodiments, however, the present invention is not limited to them. Those skilled in the art can apply various modifications and improvements to the structure and the function of the invention in accordance with each of the embodiment and the other embodiment mentioned above without departing from the spirit of the invention and the scope of the appended claims.

1. A carrier apparatus of a thin disc tray in a cartridge accommodating thin discs and thin disc trays holding the thin discs in a state of laminating a plurality of thin discs and thin disc trays in a non-fixed manner, comprising:
a containing means pressing the thin disc tray in a direction of containing it into the cartridge; and
a deflecting means pressing the thin disc tray in such a manner that a deflection is generated on the thin disc tray surface.

2. A carrier apparatus of a thin disc tray as claimed in claim 1, wherein said deflecting means is constituted by a movable arm means brought into contact with one corner or both corners of a drawn end of the thin disc tray so as to press it.

3. A carrier apparatus of a thin disc tray as claimed in claim 1, wherein said deflecting means changes a degree of deflecting the thin disc tray surface in correspondence to the contained state of the thin disc tray.

4. A carrier apparatus of a thin disc tray as claimed in claim 2, wherein said deflecting means changes a degree of deflecting the thin disc tray surface in correspondence to the contained state of the thin disc tray.

5. A carrier apparatus of a thin disc tray as claimed in claim 1, wherein said deflecting means is constituted by a taper member arranged to guide the thin disc tray such that one end or both ends of the thin disc tray which are in parallel to a drawn direction thereof is deflected, at a time when the thin disc tray is drawn.

6. A carrier method of a thin disc tray in a cartridge accommodating thin discs and thin disc trays holding the thin discs in a state of laminating a plurality of thin discs and thin disc trays in a non-fixed manner, comprising the steps of:
pressing the thin disc tray in a direction of containing it into the cartridge; and
pressing the thin disc tray in such a manner that a deflection is generated on the thin disc tray surface.

7. A carrier method of a thin disc tray as claimed in claim 6, wherein the deflection is generated on the thin disc tray surface by using a movable arm means brought into contact with one corner or both corners of the drawn end of the thin disc tray so as to press it.

8. A carrier method of a thin disc tray as claimed in claim 6, wherein a degree of deflecting the thin disc tray surface is changed in correspondence to the contained state of the thin disc tray.

9. A carrier method of a thin disc tray as claimed in claim 7, wherein a degree of deflecting the thin disc tray surface is changed in correspondence to the contained state of the thin disc tray.

10. A carrier method of a thin disc tray as claimed in claim 6, wherein the deflection is generated on the thin disc tray surface by using a taper member arranged to guide the thin disc tray such that one end or both ends of the thin disc tray which are in parallel to a drawn direction thereof are deflected, at a time when the thin disc tray is drawn.
